(19) United States
(12) Patent Application Publication
(10) Pub. No.: US 2009/0155468 A1
(43) Pub. Date: Jun. 18, 2009

(54) METROLOGY IN ELECTROLESS COBALT PLATING

(75) Inventors: Nicolai Petrov, Hamden, CT (US); Paul Figura, Orange, CT (US); Qingyun Chen, Branford, CT (US); Charles Valverde, Ansonia, CT (US); Richard Hurtubise, Clinton, CT (US)

Correspondence Address: SENNIGER POWERS LLP, 100 NORTH BROADWAY, 17TH FLOOR, ST LOUIS, MO, 63102, US

(73) Assignee: ENTHONE INC., West Haven, CT (US)

(21) Appl. No.: 11/957,554

(22) Filed: Dec. 17, 2007

(51) Int. Cl. B05D 5/12

(52) U.S. Cl. 427/306

(57) ABSTRACT

Electrolessly depositing a cobalt-based alloy on a metal surface of a substrate in a process which involves monitoring for Co³⁺ ion concentration in a sample of the electroless cobalt deposition composition during said contacting; and replacing or regenerating the electroless cobalt deposition composition when the concentration of Co³⁺ ions exceeds a predetermined concentration of Co³⁺ ions.

### FIELD OF THE INVENTION

This invention relates to the metrology of electroless depositions compositions for the deposition of cobalt and cobalt alloys in various plating industries, especially microelectronic device applications.

### BACKGROUND OF THE INVENTION

Electroless deposition of cobalt is performed in a variety of applications in the manufacture of microelectronic devices. For example, cobalt alloys are used in capping of damascene copper metallization employed to form electrical interconnects in integrated circuit substrates. Copper can diffuse rapidly into a silicon substrate and dielectric films such as, for example, SiO₂ or low-K dielectrics. Copper can also diffuse into a device layer built on top of a substrate in multilayer device applications. Such diffusion can be detrimental to the device because it can cause electrical leakage in substrates, or form an unintended electrical connection between two interconnects resulting in an electrical short. Moreover, copper diffusion out of an interconnect feature can disrupt electrical flow. Copper also has a tendency to migrate from one location to another when electrical current passes through interconnect features in service, creating voids and hillocks. This migration can damage an adjacent interconnect line and disrupt electrical flow in the feature where the metal migrates.

Accordingly, among the challenges facing integrated circuit device manufacturers is to minimize diffusion and electromigration of metal in metal-filled interconnect features. This challenge becomes more acute as the devices further miniaturize, and as the features further miniaturize and densify. Cobalt capping is employed to inhibit this Cu diffusion and migration.

Another challenge in the context of metal interconnect features is to protect them from corrosion. Certain interconnect metals, especially copper, are more susceptible to corrosion. Copper is a fairly reactive metal which readily oxidizes under ambient conditions. This reactivity can undermine adhesion to dielectrics and thin films, resulting in voids and delamination. Another challenge is therefore to combat oxidation and enhance adhesion between the cap and the copper, and between structure layers.

The industry has deposited cobalt-based caps over copper and other metal interconnect features in response to these challenges, as discussed in, for example, U.S. Pat. Nos. 7,008,872 and 7,268,074.

A particular cobalt-based metal capping layer employed to reduce copper migration, provide corrosion protection, and enhance adhesion between the dielectric and copper is a ternary alloy including cobalt, tungsten, and phosphorus. Another refractory metal may replace or be used in addition to tungsten, and boron is often substituted for or used in addition to phosphorus. Each component of the ternary alloy imparts advantages to the protective layer.

A particular problem for the integration of this technology to current ULSI fabrication lines is capping layer defectivity. In recent years, the defectivity has been an object in inventions relating to plating baths and tools. See Katakabe et al. (U.S. Pat. Pub. No. 2004/0245214), Kolics et al. (U.S. Pat. No. 6,911,067), Dubin et al. (U.S. Pat. Pub. No. 2005/0008786), Cheng et al. (U.S. Pat. No. 7,223,694), Weidman et al. (U.S. Pat. Pub. No. 2005/0084615), Pancham et al. (U.S. Pat. No. 7,223,308), and Saijo et al. (U.S. Pat. Pub. No. 2005/0009340). Defectivity reduction remains a challenge in ULSI fabrication lines.

Typical defects in electroless plated cobalt alloys for use as caps on interconnect features may be summarized as follows.

Nodulation: localized preferential growth or particle formation on the copper deposit, at copper/dielectric and copper/barrier interfaces, and on dielectric surfaces. This problem may be generally caused by a lack of stability of the working bath, and formation of incubation centers in the solution, such as Co³⁺ ions due to the oxidation of Co²⁺ ions by dissolved oxygen.

“Grain decoration”: uneven morphology of electroless cobalt film along the copper line that replicates copper erosion before plating and/or unevenly grown cobalt film due to initiation delay at copper grain interfaces. Such growth can contribute to overall deposit roughness.

Granularity: irregularly sized nanocrystallites and clusters of amorphous electroless deposits of cobalt and its alloys with large grains and well-defined grain interfaces. This type of morphology can contribute to surface roughness.

Non-uniform growth: varying deposit thickness along the Cu substrate due to different plating rate of electroless cobalt on different size features, features located in different areas, dense and isolated, and/or features with different surface areas.

Pitting: the formation of pits or pinholes due to localized incomplete copper surface coverage or extensive hydrogen bubble formation during the deposition process of the electroless film.

Those defects decrease diffusion barrier effectiveness, lower the capability of the capping layer to suppress electromigration, cause electromigration failure, affect the signal propagation across the circuitry, increase current leakage, and may even result in electrical shorts.

In both palladium-activated and self-initiated chemistries, it is thought that problems relating to decreasing deposition uniformity, increased surface roughness, and loss of selectivity could be traced to excessive Co³⁺ ion content in the electroless cobalt deposition composition. Accordingly, there exists a need for methods to monitor and control the concentration of Co³⁺ ions in electroless cobalt deposition compositions.

### SUMMARY OF THE INVENTION

Briefly, therefore, the invention is directed to a method for electrolessly depositing a cobalt-based alloy on a metal surface of a substrate, the method comprising contacting the metal surface with an electroless cobalt deposition composition comprising cobalt ions to deposit cobalt on the metal surface; quantifying a concentration of Co³⁺ ions in a sample of the electroless cobalt deposition composition during said contacting; and replacing or regenerating the electroless cobalt deposition composition when the concentration of Co³⁺ ions exceeds a predetermined concentration of Co³⁺ ions.

The invention is also directed to a method for electrolessly depositing a cobalt-based alloy on a metal surface of a substrate, the method comprising contacting the metal surface with an electroless cobalt deposition composition comprising cobalt ions and a complexing agent selected from the group consisting of citric acid, malic acid, glycine, propionic acid, succinic acid, lactic acid, methanolamine (MEA), diethanolamine (DEA), triethanolamine (TEA), ammonium chloride, ammonium sulfate, ammonium hydroxide, pyrophosphate, polyphosphate, and mixtures thereof to deposit cobalt on the metal surface; removing a sample from the electroless cobalt deposition composition; adding ethylenediaminetetraacetic acid to the sample in an amount sufficient to quantitatively chelate cobalt ions present in the sample; and subjecting the sample to quantitative chemical analysis to quantify the concentration of Co³⁺ ions in the sample; and replacing or regenerating the electroless cobalt deposition composition when the concentration of Co³⁺ ions exceeds a predetermined concentration of Co³⁺ ions.

Other objects and features of the invention will be in part apparent and in part pointed out hereinafter.

### BRIEF DESCRIPTION OF THE FIGURES

FIG. 1 is a graph depicting the induction times for electroless Co deposition compositions with: (A) no intentionally added Co³⁺ ion, (B) 10 ppm Co³⁺ ion added, (C) 20 ppm Co³⁺ ion added, (D) 30 ppm Co³⁺ ion added, and (E) 60 ppm Co³⁺ ion added.

FIG. 2 is a graph showing the effect of Co³⁺ ion present in electroless cobalt deposition compositions on deposit thickness at different metal density features of a patterned wafer substrate, the compositions comprising: (A) no intentionally added Co³⁺ ions (0 on x axis), (B) intentionally added Co³⁺ ions at a concentration of 10 ppm (10 on x axis), (C) intentionally added Co³⁺ ions at a concentration of 20 ppm (20 on x axis), and (D) intentionally added Co³⁺ ions at a concentration of 50 ppm (50 on x axis).

FIG. 3 is a UV-Vis spectrum from 320 nm to 420 nm for measuring the Co³⁺ ion concentration in electroless cobalt deposition compositions. The graph compares (A) a sample from a freshly prepared electroless cobalt deposition composition having no intentionally added Co³⁺ ion against (B) a sample from an electroless cobalt deposition composition having 93 ppm Co³⁺ ion intentionally added.

FIG. 4 is a calibration curve constructed as described in below Example 3.

### DETAILED DESCRIPTION OF PREFERRED EMBODIMENT(S)

The present invention is directed to a method for electroless deposition of cobalt onto a metal surface of a substrate. In particular, the method is directed to analyzing an electroless cobalt deposition composition during electroless deposition to quantify a concentration of Co³⁺ ions in the electroless cobalt deposition composition. According to the deposition method, at least a portion of the deposition composition is replaced when the concentration of Co³⁺ ions in the composition exceeds a concentration of Co³⁺ ions sufficient to cause spontaneous deposition of cobalt metal within the bulk solution of the electroless cobalt deposition composition.

Bath decomposition and plated deposit defectivity is thought to be caused, at least in part, by the presence of Co³⁺ ions in solution, which ions may act as incubation centers for spontaneous Co ion reduction in the bulk of the electroless deposition composition. The source of Co³⁺ ions in the composition is the oxidation of Co²⁺ ions in solution by dissolved oxygen. Dissolved oxygen may be present in an electroless deposition composition since the electroless deposition generally occurs in a deposition tank surrounding by an ambient atmosphere, i.e., air, comprising about 79% nitrogen gas and about 21% oxygen gas with trace amounts of carbon dioxide and other gases. Water exposed to the ambient atmosphere contains these gases, as predicted by Henry's Law and Dalton's Law, since the gases are, to varying extents, soluble in water. Water exposed to the atmosphere under normal conditions therefore contains about 7-10 ppm oxygen, about 13-15 ppm nitrogen, and trace amounts of carbon dioxide and other gases. The oxygen concentration in water exposed to the atmosphere is sufficient to oxidize enough Co²⁺ to Co³⁺ to significantly affect bath deposition performance and the quality of the plated deposit. Plating bath decomposition, spontaneous deposition in solution, and longer induction times (and even the prevention of plating induction) can be traced to trace amounts of Co³⁺ ion in solution. It has been observed that a Co³⁺ ion concentration as low as about 60 ppm is sufficient to prevent plating induction for commercially practical purposes.

Problems related to the oxidation of Co²⁺ ions to Co³⁺ ions during electroless cobalt plating have not been the study of extensive research. The present invention is directed to a method of monitoring the concentration of Co³⁺ ion in an electroless cobalt deposition composition. This method allows for careful control of plating bath conditions and the inhibition of plating defects and bath decomposition. The concentration of Co³⁺ ions is therefore a proxy for bath instability. In other words, when the concentration of Co³⁺ ions exceeds a pre-determined value, steps may be taken to prevent plating defects from occurring which are attributable to bath instability. Experimental evidence to date indicates that the risks of bath instability, deposit defectivity, and spontaneous decomposition increase when the concentration of Co³⁺ ions exceeds about 100 ppm, about 60 ppm, or even about 30 ppm. Accordingly, when the Co³⁺ ion concentration exceeds a pre-determined threshold, at least a portion of the electroless deposition composition is replaced with fresh solution, and in one embodiment, the entire electroless deposition composition may be replaced with fresh solution.

In one embodiment, the concentration of Co³⁺ ions in the electroless cobalt deposition composition is determined by UV/VIS spectrophotometry. The concentration of Co³⁺ ions in an electroless cobalt deposition composition is relatively small compared to the concentration of Co²⁺ ions, which are the primary source of cobalt metal in the electrolessly deposited cobalt-based alloy. Accordingly, accurately determining the concentration of Co³⁺ ions in a composition comprising a greater concentration of Co²⁺ ions is challenging in the metrology of electroless cobalt deposition compositions, especially since Co²⁺ ions and Co³⁺ ions have, in many regards, similar chemical properties. The respective cobalt ions, however, differ in their light absorption properties when present in complexes with certain chelating agents. In one embodiment, the concentration of Co³⁺ ions in the bulk of the electroless cobalt deposition composition may be determined using UV/VIS spectrophotometry on a sample in which the cobalt ions in solution are quantitatively chelated with ethylenediaminetetraacetic acid (EDTA). It has been discovered that that Co³⁺-ethylenediaminetetraacetic acid (Co³⁺-EDTA) complex has absorption maxima at 380 nm and 535 nm, while Co²⁺-ethylenediaminetetraacetic acid (Co²⁺-EDTA) complex has a maximum at 490 nm. The difference in absorption at 380 nm is particularly well-suited for the determination of the concentration of Co³⁺ ions in solution since the extinction coefficient of the Co³⁺-ethylenediaminetetraacetic acid (Co³⁺-EDTA) complex (137.5 M⁻¹cm⁻¹) is much larger than the extinction coefficient of the Co²⁺-ethylenediaminetetraacetic acid (Co²⁺-EDTA) complex (0.6 M⁻¹cm⁻¹) at 380 nm.

For example, a deposition composition comprising a Co³⁺ ion concentration of about 90 ppm, which is about 1.5 mM, in which enough EDTA is added for quantitative chelation of cobalt ions yields an absorption reading at 380 nm of 0.21 units in a one centimeter length cell. In contrast, a deposition composition comprising a Co²⁺ ion concentration of about 6000 ppm, which is about 0.1 M, in which enough EDTA is added for quantitative chelation yields an absorption reading at 380 nm of 0.06 units in a one centimeter length cell. By normalizing the comparatively smaller signal of the Co²⁺-EDTA complex, the concentration of Co³⁺ ions can be accurately determined down to a limit of detection of about 5 ppm Co³⁺ ion.

EDTA is particularly well-suited for the metrology of Co³⁺ ions in solution for the additional reason that it is a stronger complexing agent than typical complexing agents used in electroless Co deposition compositions. In a sample taken from an electroless cobalt deposition composition, EDTA will displace the chelate, such as citrate, already present in a cross-chelation reaction. EDTA, being a much stronger chelating agent, typically cross-chelates quantitatively, that is, at least about 99.9%, so that there is minimal interference in the UV/VIS signal from complexes comprising cobalt ions and citrate.

According to the metrology method of the present invention, samples are periodically removed from the electroless cobalt deposition composition during a plating operation. The sample size may vary from about 5 mL to about 40 mL, such as about 20 mL. Although any volume sample may be measured according to this method, smaller samples are preferred to avoid disrupting electroless plating and to minimize the amount of EDTA used to measure the Co³⁺ ion concentration. Samples may be removed periodically, such as between about every 12 and every 24 hours, or after between about 100 and about 500 substrates have been treated with the electroless cobalt deposition composition. For a bath that is used to plate wafers in production, the test is preferably based on the number of substrates plated.

According to such factors as the initial concentration of cobalt ions added, the length of time during which plating has occurred, and whether any cobalt was added to refresh the bath, the approximate concentration of cobalt can be determined. Based on this approximation, EDTA is added to the sample in an amount sufficient to quantitatively chelate Co²⁺ and Co³⁺ ions. Accordingly, for a sample having an approximate total cobalt ion concentration of about 6 g/L, for example, an EDTA concentration sufficient to quantitatively chelate Co²⁺ and Co³⁺ ions can be between about 0.1M and about 0.4M. Typically, the EDTA concentration in the sample will be between about 0.15M and about 0.3M, more typically between about 0.2M and about 0.25M. If too little EDTA is added, the EDTA may not be sufficient to quantitatively complex all of the cobalt ions. By “quantitative,” it is meant that the EDTA chelates between about 99% and about 99.9% of the cobalt ions, such as about 99.9%. The maximum concentration of added EDTA is typically limited by its solubility in solution. Accordingly, the concentration is kept below a concentration that poses a risk of precipitation.

After addition of the EDTA, the sample may be allowed to rest to ensure quantitative cross-chelation. The cross-chelation kinetics may vary from one electroless deposition composition to another, depending in large part on the chelating agent employed.

The kinetics of the reaction will depend on the kinetic characteristics of the particular complex of either Co³⁺ ion or Co²⁺ ion. In general, the ligand exchange reaction will favor formation of the Co EDTA complexes, since the stability constants of those are higher than for any other ligand. Stability constants are as follows:

| | Co²⁺ | Co³⁺ |
|---|---|---|
| Citrate | 5 | — |
| Glycine | 4.5 | — |
| Malate | 2.9 | — |
| EDTA | 16.5 | 41.4 |

Also, typically Co³⁺ complexes are more stable than Co²⁺ ones. Kinetics can be changed (make reaction to go faster) by heating the reactants or mixing them. To ensure quantitative cross-chelation, sample resting times should be at least 180 minutes. The sample temperature may be between about 50° C. and about 80° C., preferably between about 70° C. and about 80° C., such as about 80° C. Since the cross-chelation reaction takes a certain amount of time, it is preferred to start metrology after at least 3 hrs of mixing the solution with EDTA and heating it to 80° C. and then cooling it down to room temperature. It typically takes from several weeks to 2 months to accumulate approx. 50 ppm of Co³⁺ in the operating solution. If the sample is kept tightly closed it is assumed there is no Co³⁺ generation in the sample. The solution will have eventual Co³⁺ generation, since it is exposed to air during plating.

After sample removal and quantitative cross-chelation, the samples are tested by UV/VIS spectrophotometry. Ultraviolet-visible spectroscopy or ultraviolet-visible spectrophotometry (UV/VIS) methods are known. UV/VIS spectroscopy uses light in the visible (400-750 nm wavelength), adjacent near ultraviolet (UV) (300-400 nm wavelength), and near infrared (NIR) (approximately 750 nm-1 mm) ranges. In this region of energy, molecules undergo electronic transitions.

According to the Beer-Lambert law, the absorbance of a solution is directly proportional to the concentration of components in solution. Thus, UV/VIS spectrophotometry can be used to determine the concentration of a particular component. Concentrations may be determined by measuring absorption and the value is used in conjunction with tables of molar extinction coefficients, or to more accurately determine concentration, by constructing a calibration curve.

The instrument used in ultraviolet-visible spectroscopy is called a UV/VIS spectrophotometer. The basic parts of a spectrophotometer include a light source (often an incandescent bulb for the visible wavelengths, or a deuterium arc lamp in the ultraviolet), a holder for the sample, a diffraction grating or monochromator to separate the different wavelengths of light, and a detector. The detector is typically a photodiode or a CCD. Photodiodes are used with monochromators, which filter the light so that only light of a single wavelength reaches the detector. Diffraction gratings are used with CCDs, which collects light of different wavelengths on different pixels. A spectrophotometer can be either single beam or double beam. In a single beam instrument all of the light passes through the sample cell. Iₒ must be measured by removing the sample. In a double-beam instrument, the light is split into two beams before it reaches the sample. One beam is used as the reference; the other beam passes through the sample.

The UV/VIS spectrophotometer measures the intensity of light passing through a sample (I), and compares it to the intensity of light before it passes through the sample (Iₒ). The ratio I/Iₒ is called the transmittance, and is usually expressed as a percentage (% T). The absorbance, A, is based on the transmittance according to the following equation (1):

A=−log(% T) (1)

Concentration may be determined using the following equation (2):

A=∈·c·L (2)

wherein ∈ is the molar extinction coefficient (expressed in terms of M⁻¹cm⁻¹), c is the molar concentration of the component of interest, and L is the path length through the cuvette, which is typically 1 cm. By measuring the absorbance of the solution at 380 nm, the concentration of the Co³⁺-EDTA complex and thus, the concentration of Co³⁺ ions can be accurately determined down to a limit of detection of about 5 ppm Co³⁺ ion. When the Co³⁺ ion concentration exceeds a threshold at which the risk of bath instability, spontaneous bath decomposition, and deposit defectivity increases, at least a portion of the electroless cobalt deposition composition is replaced with a fresh solution, and in some embodiments, all of the electroless deposition composition is replaced with fresh solution. According to experimental results, bath replacement preferably occurs when the Co³⁺ ion concentration exceeds about 100 ppm, preferably when the concentration exceeds about 60 ppm, more preferably when the concentration exceeds about 30 ppm.

In an electroless cobalt deposition method, a substrate having a metal surface is exposed to an electroless deposition composition. Typically, the electroless deposition composition comprises a source of cobalt ions, a reducing agent, and a complexing and/or chelating agent. The bath is buffered within a certain pH range. Optionally, the bath may also comprise a source of refractory ions.

For the deposition of the cobalt-based alloy, the bath comprises a source of Co ions. In the context of capping of electrical interconnects, cobalt-based alloys provide several advantages. They do not significantly alter the electrical conductivity characteristics of copper. Cobalt provides good barrier and electromigration protection for copper. Cobalt, which is selected in significant part because it is immiscible with copper, does not tend to alloy with copper during assembly or over time during service. The Co ions are introduced into the solution as an inorganic cobalt salt such as the hydroxide, chloride, sulfate, or other suitable inorganic salt, or a cobalt complex with an organic carboxylic acid such as Co acetate, citrate, lactate, succinate, propionate, hydroxyacetate, or others. Co(OH)₂ may be used where it is desirable to avoid overconcentrating the solution with Cl⁻ or other anions. In one embodiment, the cobalt salt or complex is added to provide about 2 g/L to about 20 g/L of Co²⁺ to yield a cobalt-based alloy of high Co metal content. In some applications, the cobalt content in the electroless bath is very low, for example, as low as between about 0.5 g/L and about 2.0 g/L of Co²⁺.

Depending upon the deposition mechanism and the desired alloy, the reducing agent is chosen from either a phosphorus-based reducing agent or a borane-based reducing agent. The deposition mechanism and the desired alloy dictate the choice of the reducing agent. If an alloy is desired which contains phosphorus, hypophosphite can be chosen. If an alloy is desired which contains boron, a borane-based reducing agent can be chosen, such as borohydride or a borane. Additionally, both phosphorous-based and borane-based reducing agents may be added to the plating bath.

Among the phosphorus-based reducing agents, hypophosphite is a preferred reducing agent in electroless plating films because of its low cost and docile behavior as compared to other reducing agents. When hypophosphite is chosen as the reducing agent, the finished alloy contains phosphorus. As is known, the plating solution requires an excess of H₂PO₂⁻ to reduce Co²⁺ into the cobalt alloy. As noted in Mallory and Hajdu, pp. 62-68, the molar ratio of Co ions to hypophosphite ions in the plating solution is between 0.25 to 0.60, preferably between 0.30 and 0.45, for example. To ensure that a sufficient concentration of hypophosphite is present in the plating bath for rapid initiation of plating and improved plating morphology, the hypophosphite salt is added in an initial concentration of about 2 g/L to about 30 g/L, for example about 21 g/L. Exemplary hypophosphite salts include ammonium hypophosphite, sodium hypophosphite, and potassium hypophosphite.

Hypophosphite reduces the metal ion spontaneously only upon a limited number of substrates, including cobalt, nickel, and palladium. Not included in this list is copper, which is a particular metal of interest for its use in filling interconnect features such as vias and trenches in microelectronic devices. For hypophosphite reduction over a copper substrate, the copper surface must first be activated, for example, by seeding with the metal to be deposited (i.e., cobalt) by treating the surface with a solution comprising a strong reducing agent such as DMAB and ions of the metal to be plated (i.e., Co²⁺) or by seeding with a catalyst such as palladium.

Other preferred reducing agents include the borane-based reducing agents, such as borohydrides (sodium, potassium, cyano, trimethoxy, and tetramethylammonium, among others), monomethyl amine borane, isopropyl amine borane, dimethyl amine borane (DMAB), diethyl amine borane (DEAB), trimethyl amine borane, triethyl amine borane, triisopropyl amine borane, pyridine borane, and morpholine borane. When a borane-based reducing agent is chosen, boron becomes part of the plated alloy. As is known, the plating solution requires approximately equal molar amounts of the borane-based reducing agent to reduce Co²⁺ into the cobalt alloy. To ensure that a sufficient concentration of reducing agent for self-initiated deposition is present in the plating bath, dimethyl amine borane, for example, is added in an initial concentration of about 0.5 g/L to about 30 g/L, for example about 10 g/L.

Unlike hypophosphite, plating solutions with borane-based reducing agents do not need a copper surface activation step. Instead, the reducing agent catalyzes reduction of the metal ion onto the copper surface.

Due to the oxidation of the reducing agent, phosphorus or boron co-deposits with the cobalt. An effect of these elements in the deposit is to reduce grain size and enhance amorphousness, which can render the microstructure more impervious to copper diffusion and electromigration. For example, a ternary alloy comprising cobalt, tungsten, and boron with high tungsten content has an amorphous phase. Without being bound to a particular theory, it is believed that the presence of refractory metal together with boron and/or phosphorus improves the barrier properties by filling in the grain boundaries of the crystalline structure of the deposit.

The bath further may contain agents for pH adjustment and buffering agents. The bath pH is typically controlled by one or more pH adjusters and typically contains a pH buffer to stabilize the pH within the desired pH range. In one embodiment, the desired pH range is from about 7.5 to about 10. In one embodiment, it is from about 8 to about 10. Exemplary agents for pH adjustment include potassium hydroxide (KOH), tetramethylammonium hydroxide (TMAOH), tetraethylammonium hydroxide (TEAOH), tetrapropylammonium hydroxide (TPAOH), tetrabutylammonium hydroxide (TBAOH), methyltriethylammonium hydroxide (MTEOH), ethyltrimethylammonium hydroxide (ETEOH), benzyltrimethylammonium hydroxide (BTEOH), ammonia, and other amines. Exemplary buffering agents include, for example, borates, tetra- and pentaborates, phosphates, ammonia, and hydroxylamines such as monoethanolamine, diethanolamine, triethanolamine, and ethylenediamine, among others. The pH buffer level is on the order of between about 2 g/L and about 50 g/L.

A complexing and/or chelating agent helps to keep Co ions in solution. Because the bath is typically operated at a mildly alkaline pH of between about 7.5 and about 10, Co²⁺ ions have a tendency to form hydroxide salts and precipitate out of solution. The complexing agents used in the bath are selected from among citric acid, malic acid, glycine, propionic, succinic, lactic acids, methanolamine (MEA), diethanolamine (DEA), triethanolamine (TEA), and ammonium salts such as ammonium chloride, ammonium sulfate, ammonium hydroxide, pyrophosphate, polyphosphate, and mixtures thereof.

Some complexing agents, such as cyanide, are avoided because they complex with Co ions too strongly and can prevent deposition from occurring. The complexing agent concentration is selected such that the molar ratio between the complexing agent and Co ion is between about 2:1 and about 10:1, generally. Depending on the complexing agent molecular weight, the level of complexing agent may be on the order of between about 10 g/L and about 200 g/L.

If desired, the plating bath may also include a refractory metal ion, such as tungsten or rhenium, which functions to increase thermal stability, corrosion resistance, and diffusion resistance. Exemplary sources of W ions are tungsten trioxide, tungstic acids, ammonium tungstic acid salts, tetramethylammonium tungstic acid salts, and alkali metal tungstic acid salts, phosphotungstic acid, silicotungstate, other heteropolytungstic acids and other mixtures thereof. For example, one preferred deposition bath contains between about 0.1 g/L and about 10 g/L of tungstic acid. Other sources of refractory metal include rhenium trioxides, perrhenic acids, ammonium perrhenic acid salts, tetramethylammonium perrhenic acid salts, alkali metal perrhenic acid salts, heteropolyacids of rhenium, and other mixtures thereof.

Other additives, as are known in the art such as levelers, accelerators, and grain refiners may also be added. At low concentrations, hydrazine may be added as a leveler, as disclosed in U.S. Pat. Pub. 2006/0083850. Levelers act with the stabilizer of the invention to further enhance deposition morphology and topography, and also to control the deposition rate. Some additives which may be added to the deposition compositions are disclosed in U.S. Pat. Pub. 2007/0066057.

In some applications, the bath must be substantially sodium free, or alkali metal ion free.

Employing the foregoing baths, a variety of alloys can be deposited. For example, cobalt diffusion barrier layers include Co—W—P, Co—W—B, Co—W—B—P, Co—B—P, Co—B, Co—Mo—B, Co—W—Mo—B, Co—W—Mo—B—P, and Co—Mo—P, among others.

According to the practice of electroless deposition, a layer of cobalt or cobalt alloy may be deposited by exposure of the electroless deposition compositions to, for example, a patterned silicon substrate having vias and trenches, in which a metal layer, such as copper, has already filled into the vias or trenches. This exposure may comprise dip, flood immersion, spray, or other manner of exposing the substrate to a deposition bath, with the provision that the manner of exposure adequately achieves the objectives of depositing a metal layer of the desired thickness and integrity.

In applications where the invention is used for capping, surface preparation may be needed for removing organic residues left by CMP and for dissolving copper oxides from the copper surface. Unless removed, the oxide can interfere with adhesion of the cap and can detract from electrical conductivity.

Acidic pretreatment involves exposing the substrate to an acid selected from among HCl, H₂SO₄, citric acid, methanesulfonic acid, and H₃PO₄ to remove CMP residues, copper oxides, and copper embedded in the dielectric by CMP. After the acidic pretreatment operation is completed, the substrate is rinsed by, e.g., DI water.

Alternatively or additionally, an alkaline pretreatment employs basic cleaner for removing oxide from the metal interconnect feature. This cleaner preferably removes all the oxide, for example copper oxides, without removing substantial amounts of the interconnect metallization. Typical basic cleaners contain TMAOH with addition of hydroxylamine, MEA, TEA, EDA (ethylenediamine), or DTA (diethylenetriamine) at pH range of 9 to 12. A water rinse follows the alkaline pretreatment.

The electroless deposition compositions according to the present invention may be used in conventional continuous mode deposition processes. In the continuous mode, the same bath volume is used to treat a large number of substrates. In this mode, reactants must be periodically replenished, and reaction products accumulate, necessitating periodic removal of the plating bath. Preferably, in this mode, the bath contains an initially high concentration of metals ions for depositing onto the substrate.

For auto-catalyzation of the electroless deposition, borane-based reducing agents may be employed such as, for example borohydrides (sodium, potassium, cyano-, trimethoxy, and tetramethylammonium, among others), monomethyl amine borane, isopropyl amine borane, dimethyl amine borane (DMAB), diethyl amine borane (DEAB), trimethyl amine borane, triethyl amine borane, triisopropyl amine borane, pyridine borane, and morpholine borane, mixtures thereof, or mixtures thereof with hypophosphite. Oxidation/reduction reactions involving the borane-based reducing agents and Co deposition ions are catalyzed by copper. In particular, at certain plating conditions, e.g., pH and temperature, the reducing agents are oxidized in the presence of copper, thereby reducing the deposition ions to metal which deposits on the copper. The process is preferably substantially self-aligning in that the metal is deposited essentially only on the copper interconnect. However, conventional electroless plating baths deposit a cobalt alloy that amplifies the roughness of the underlying copper interconnect. In many instances, stray cobalt is deposited onto the dielectric. If the additives are added to the plating solution, as in the present invention, the electroless plating bath deposits a smooth and level cobalt or cobalt alloy capping layer without stray deposition onto the dielectric.

As an alternative, certain embodiments of the invention employ an electroless deposition process which does not employ a reducing agent which renders copper catalytic to metal deposition. For such processes a surface activation operation is employed to facilitate subsequent electroless deposition. A currently preferred surface activation process utilizes a palladium immersion reaction. Other known catalysts are suitable and include rhodium, ruthenium, platinum, iridium, and osmium. Alternatively, the surface may be prepared for electroless deposition by seeding as with, for example, cobalt seeding deposited by electroless deposition, electrolytic deposition, PVD, CVD, or other technique as is known in the art.

Plating typically occurs at a bath temperature of between about 50° C. to about 90° C. If the plating temperature is too low, the reduction rate is too low, and at a low enough temperature, Co ion reduction does not initiate at all. At too high a temperature, the plating rate increases, and the bath can become too active. For example, Co ion reduction can become less selective, and cobalt plating may occur not just on the copper interconnect features of a wafer substrate, but also on the dielectric material. Further, at very high temperatures, Co ion reduction can occur spontaneously within the bath plating solution and on the sidewalls of the plating tank. Plating rates achievable using the electroless deposition compositions of the present invention may be between about 50 Å/minute and about 300 Å/minute. Plating typically occurs for between about 1 minute and about 3 minutes. Accordingly, cobalt alloy capping layers having thicknesses between 50 Å and about 300 Å are routinely achieved, which capping layers are substantially defect free, uniform, and smooth as electrolessly deposited.

During the plating operation, samples are periodically taken from the electroless deposition composition and analyzed for Co³⁺ ion concentration according to the method described above. When the Co³⁺ ion concentration exceeds a pre-determined threshold, which may be 100 ppm, 60 ppm, or 30 ppm, the electroless deposition composition may be replaced with fresh solution.

The following examples further illustrate the invention.

### Example 1

### Determination of Induction Time for Electroless Deposition Compositions Comprising Known Concentrations of Co³⁺ Ion

Co³⁺ ions present in the electroless deposition composition may lengthen plating induction time, or even inhibit plating induction altogether. To test concentrations at which plating induction time is lengthened, electroless cobalt deposition compositions were prepared having known Co³⁺ concentrations. Five electroless cobalt deposition compositions were prepared. The electroless cobalt deposition compositions contained the following components and approximate concentrations:

20-40 g/L CoCl₂.6H₂O

40-80 g/L C₆H₈O₇ (citric acid)

10-30 g/L H₃BO₃ (boric acid)

4-12 g/L H₂WO₄ (tungstic acid)

1-5 g/L NH₄H₂PO₂ (ammonium hypophosphite)

1-5 g/L (CH₃)₂NHBH₃ (borane dimethylamine complex)

0.05-0.2 g/L (NH₄)₂Mo₂O₇ (ammonium dimolybdate)

0.1-0.5 g/L Calfoam EA 603 (Ammonium Laureth Sulfate)

pH was adjusted to between 8.0 and 9.5 with (CH₃)₄N(OH) (TMAH, tetramethylammonium hydroxide).

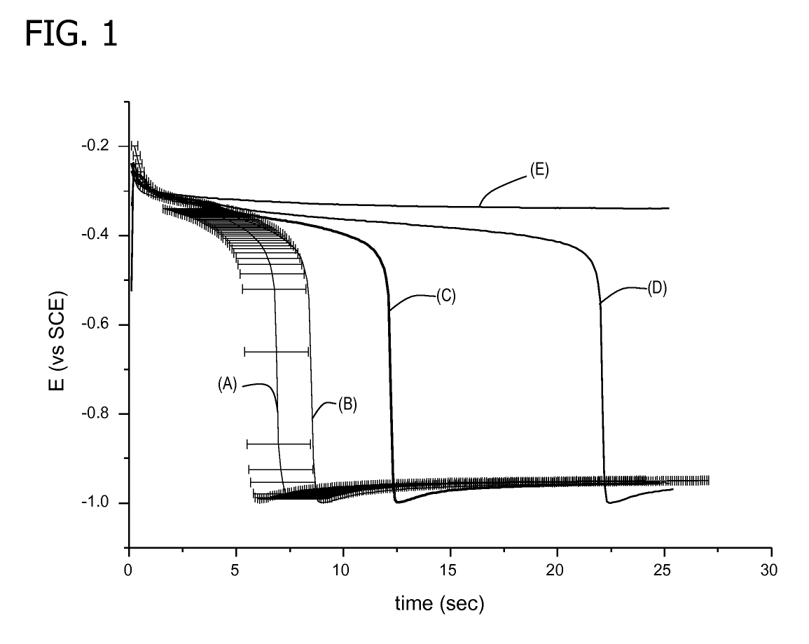

One composition was prepared with no intentionally added Co³⁺ ion. Four other compositions were prepared to have 10 ppm, 20 ppm, 30 ppm, and 60 ppm Co³⁺ ion intentionally added. The compositions were used to plate Co alloy, and the induction times for each composition were measured. The freshly prepared solution having no intentionally added Co³⁺ ion was used to plate four Co alloy deposits. FIG. 1 is a graph depicting the induction times for the compositions: (A) no intentionally added Co³⁺ ion, (B) 10 ppm Co³⁺ ion added, (C) 20 ppm Co³⁺ ion added, (D) 30 ppm Co³⁺ ion added, and (E) 60 ppm Co³⁺ ion added. It can be seen from the graph depicted in FIG. 1 that even low concentrations of Co³⁺ ion can lengthen Co deposition induction, and concentrations as low as 60 ppm can prevent induction altogether for commercially practical purposes.

### Example 2

### Determination of Deposition Height Variance for Electroless Deposition Compositions Comprising Known Concentrations of Co³⁺ Ion

Co³⁺ ions may affect the deposit thickness at features having different densities on a patterned wafer substrate. Accordingly, electroless cobalt deposition compositions were prepared having known Co³⁺ concentrations. Four electroless cobalt deposition compositions were prepared. The electroless cobalt deposition composition contained the following components and approximate concentrations:

20-40 g/L CoCl₂.6H₂O

40-80 g/L C₆H₈O₇ (citric acid)

10-30 g/L H₃BO₃ (boric acid)

4-12 g/L H₂WO₄ (tungstic acid)

1-5 g/L NH₄H₂PO₂ (ammonium hypophosphite)

1-5 g/L (CH₃)₂NHBH₃ (borane dimethylamine complex)

0.05-0.2 g/L (NH₄)₂Mo₂O₇ (ammonium dimolybdate)

0.1-0.5 g/L Calfoam EA 603 (Ammonium Laureth Sulfate)

pH was adjusted to between 8.0 and 9.5 with (CH₃)₄N(OH) (TMAH, tetramethylammonium hydroxide).

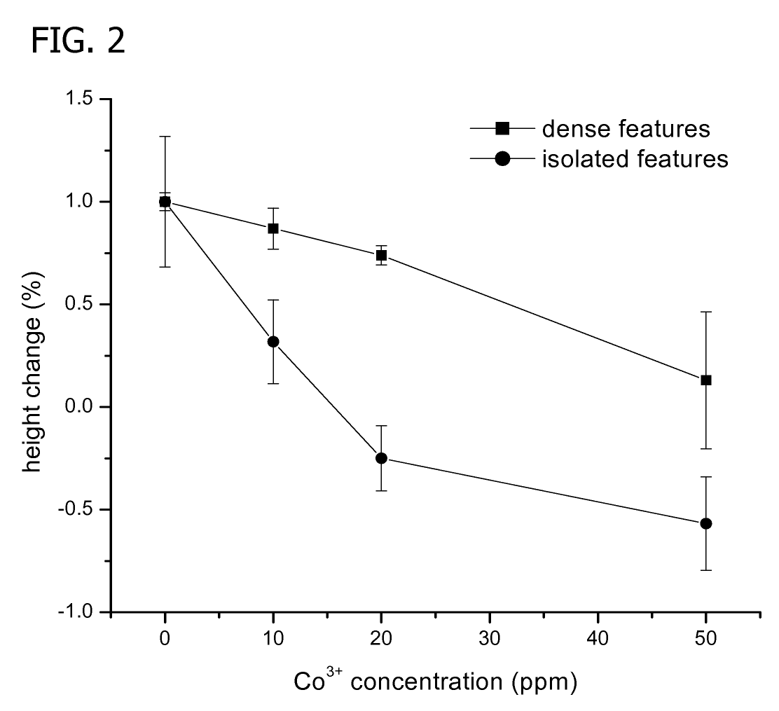

One composition was prepared with no intentionally added Co³⁺ ion. Three other compositions were prepared having 10 ppm, 20 ppm, and 50 ppm Co³⁺ ion added. The compositions were used to plate cobalt alloy, and height variances for plated deposits from each composition at different feature densities (dense and isolated) were determined. As shown in FIG. 2, height variances are more negatively impacted at isolated features (--) compared to dense features (-▪-). It is thought that since the Co³⁺ concentration is low and under the diffusion limit control range, the deposit thickness uniformity over different features is significantly affected due to plating initiation delay at more isolated lines compared with dense lines.

### Example 3

### UV-Vis Spectrophotometric Determination of Co³⁺ Ions in Electroless Co Plating Composition

Two electroless deposition compositions were prepared comprising the following components and approximate concentrations:

20-40 g/L CoCl₂.6H₂O

40-80 g/L C₆H₈O₇ (citric acid)

10-30 g/L H₃BO₃ (boric acid)

4-12 g/L H₂WO₄ (tungstic acid)

1-5 g/L NH₄H₂PO₂ (ammonium hypophosphite)

1-5 g/L (CH₃)₂NHBH₃ (borane dimethylamine complex)

0.05-0.2 g/L (NH₄)₂Mo₂O₇ (ammonium dimolybdate)

0.1-0.5 g/L Calfoam EA 603 (Ammonium Laureth Sulfate)

pH was adjusted to between 8.0 and 9.5 with (CH₃)₄N(OH) (TMAH, tetramethylammonium hydroxide).

A control bath was prepared having only these components. A test bath was also prepared further comprising 93 ppm intentionally added Co³⁺ ion.

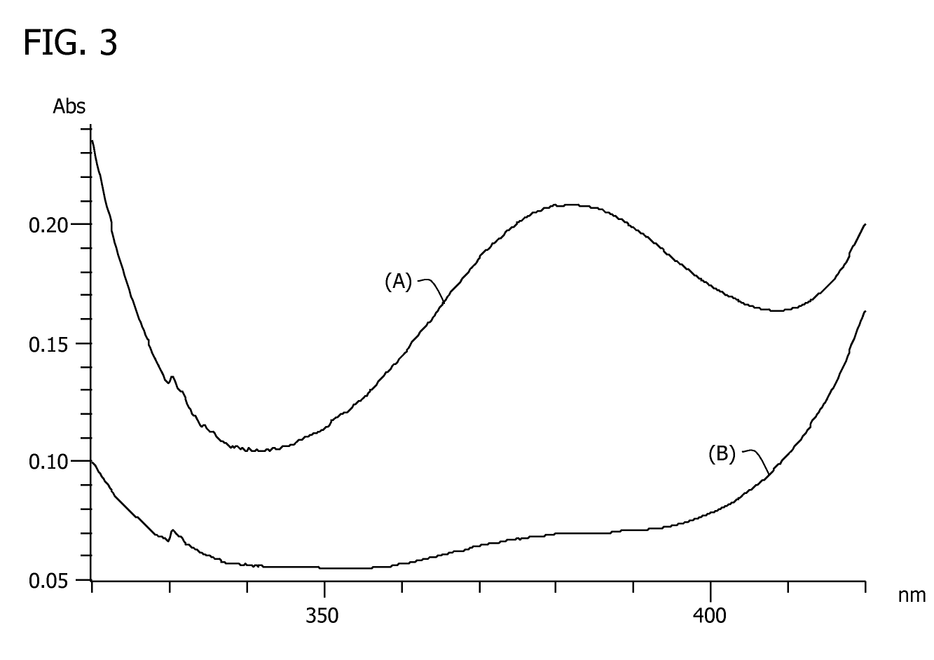

Samples of both compositions (20 mL) were taken and 1 g EDTA were added to quantitatively complex the cobalt ions. Quantitative interchelation (replacement of citrate by EDTA) was ensured by allowing the mixture to stand for 30 minutes. UV-VIS spectra were obtained for both the control bath and the bath containing intentionally added Co³⁺ ion. See FIG. 3, which shows that the Co³⁺-EDTA complex (Curve A) absorbs substantially more light over a broad range of wavelengths than the Co²⁺-EDTA complex (Curve B).

Absorbances of Co³⁺-EDTA at 380 nm for various concentrations were recorded, and the absorbance data were used to construct a calibration curve. The following table shows the absorbance reading for each Co³⁺ ion concentration measured:

| ppm Co³⁺ | Absorbance |
|---|---|
| 0 | 0.07 |
| 43 | 0.131 |
| 95 | 0.22 |
| 155 | 0.31 |

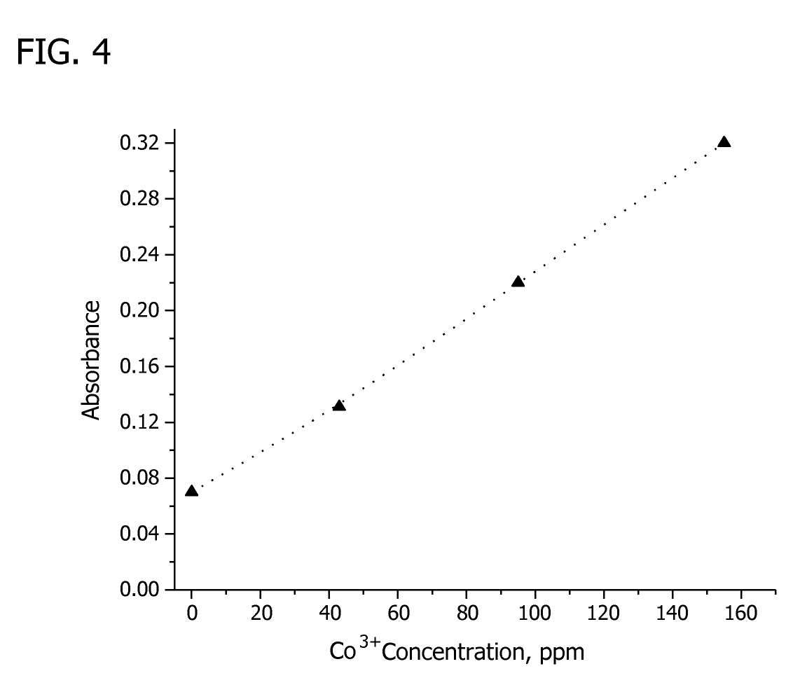

The calibration curve constructed from these data is shown at FIG. 4. A calibration curve similarly constructed may be used to determine the concentration of Co³⁺ ion in unknown electroless cobalt deposition compositions, and to determine when the concentration has become high enough to adversely affect bath stability and deposit quality. Once this concentration is reached, at least a portion of and preferably the entire electroless cobalt deposition composition is replaced with fresh solution.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. For example, that the foregoing description and following claims refer to “an” interconnect means that there are one or more such interconnects. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

We claim:

1. A method for electrolessly depositing a cobalt-based alloy on a metal surface of a substrate, the method comprising:
contacting the metal surface with an electroless cobalt deposition composition comprising cobalt ions to deposit cobalt on the metal surface;
quantifying a concentration of Co³⁺ ions in a sample of the electroless cobalt deposition composition during said contacting; and
replacing or regenerating the electroless cobalt deposition composition when the concentration of Co³⁺ ions exceeds a predetermined concentration of Co³⁺ ions.

2. The method of claim 1 wherein the predetermined concentration of Co³⁺ ions is predetermined as a function of a concentration of Co³⁺ ions sufficient to cause spontaneous deposition of cobalt metal in the bulk solution of the electroless cobalt deposition composition.

3. The method of claim 1 wherein the electroless cobalt deposition composition further comprises a complexing agent selected from the group consisting of citric acid, malic acid, glycine, propionic acid, succinic acid, lactic acid, methanolamine (MEA), diethanolamine (DEA), triethanolamine (TEA), ammonium chloride, ammonium sulfate, ammonium hydroxide, pyrophosphate, polyphosphate, and mixtures thereof.

4. The method of claim 1 wherein said quantifying the concentration of Co³⁺ ions in the sample is accomplished by removing the sample from the electroless cobalt deposition composition and subjecting the sample to quantitative chemical analysis to quantify the concentration of Co³⁺ ions in the sample.

5. The method of claim 4 further comprising the step of adding ethylenediaminetetraacetic acid to the sample in an amount sufficient to quantitatively chelate cobalt ions present in the sample.

6. The method of claim 4 wherein the concentration of Co³⁺ ions in the electroless cobalt deposition composition is quantified using UV-Vis spectrophotometry.

7. The method of claim 4 wherein the concentration of cobalt ions in the sample is between about 0.5 g/l and about 20 g/l.

8. The method of claim 5 wherein the ethylenediaminetetraacetic acid is added to the sample in a concentration between about 50 g/l and about 100 g/l.

9. The method of claim 1 wherein the predetermined concentration of Co³⁺ ions is about 100 ppm.

10. The method of claim 1 wherein the predetermined concentration of Co³⁺ ions is about 60 ppm.

11. The method of claim 1 wherein the predetermined concentration of Co³⁺ ions is about 30 ppm.

12. A method for electrolessly depositing a cobalt-based alloy on a metal surface of a substrate, the method comprising:
contacting the metal surface with an electroless cobalt deposition composition comprising cobalt ions to deposit cobalt on the metal surface;
removing a sample from the electroless cobalt deposition composition;
adding a chelating agent to the sample in an amount sufficient to quantitatively chelate cobalt ions present in the sample;
subjecting the sample to quantitative chemical analysis to quantify the concentration of Co³⁺ ions in the sample; and
replacing or regenerating the electroless cobalt deposition composition when the concentration of Co³⁺ ions exceeds a predetermined concentration of Co³⁺ ions.

13. A method for electrolessly depositing a cobalt-based alloy on a metal surface of a substrate, the method comprising:
contacting the metal surface with an electroless cobalt deposition composition comprising cobalt ions and a complexing agent selected from the group consisting of citric acid, malic acid, glycine, propionic acid, succinic acid, lactic acid, methanolamine (MEA), diethanolamine (DEA), triethanolamine (TEA), ammonium chloride, ammonium sulfate, ammonium hydroxide, pyrophosphate, polyphosphate, and mixtures thereof to deposit cobalt on the metal surface;
removing a sample from the electroless cobalt deposition composition;
adding ethylenediaminetetraacetic acid to the sample in an amount sufficient to quantitatively chelate cobalt ions present in the sample;
subjecting the sample to quantitative chemical analysis to quantify the concentration of Co³⁺ ions in the sample; and
replacing or regenerating the electroless cobalt deposition composition when the concentration of Co³⁺ ions exceeds a predetermined concentration of Co³⁺ ions.

14. The method of claim 13 wherein the subjecting the sample to quantitative chemical analysis comprises subjecting the sample to UV-Vis spectrophotometry.

15. The method of claim 13 wherein the sample has a cobalt ion concentration between about 0.5 g/l and about 20 g/l.

16. The method of claim 13 wherein the ethylenediaminetetraacetic acid is added to the sample in a concentration between about 50 g/l and about 100 g/l.

17. The method of claim 13 wherein the predetermined concentration of Co³⁺ ions is about 100 ppm.

18. The method of claim 13 wherein the predetermined concentration of Co³⁺ ions is about 60 ppm.

19. The method of claim 1 wherein the predetermined concentration of Co³⁺ ions is about 30 ppm.

20. The method of claim 13 wherein the subjecting the sample to quantitative chemical analysis comprises subjecting the sample to UV-Vis spectrophotometry and determining the concentration of Co³⁺ ions with the aid of a calibration curve plotting absorbance versus Co³⁺ ion concentration, wherein the sample has a cobalt ion concentration between about 0.5 g/l and about 20 g/l, and wherein the ethylenediaminetetraacetic acid is added to the sample in a concentration between about 50 g/l and about 100 g/l.
